(19) United States
(12) Patent Application Publication
(10) Pub. No.: US 2020/0065781 A1
(43) Pub. Date: Feb. 27, 2020

(54) SYSTEM AND METHOD FOR EARNING MONETARY REWARDS FOR IN-GAME PURCHASES

(71) Applicant: PlayCache, LLC, RANCH SANTA MARGARITA, CA (US)

(72) Inventors: MATTHEW PAUL SCOTT, RANCH SANTA MARGARITA, CA (US); JOY CATACUTAN-FERRER MONTOYA, RANCH SANTA MARGARITA, CA (US)

(21) Appl. No.: 16/110,283

(22) Filed: Aug. 23, 2018

(51) Int. Cl. G06Q 20/06; G06K 9/00; G06Q 20/12

(52) U.S. Cl. CPC G06Q 20/06; G06Q 20/123; G06K 9/00664

(57) ABSTRACT

A method comprising: entering at least one task to be performed by a child, wherein the at least one task has a designated timeframe when the at least one task has to be completed and a monetary reward to be credited to a portfolio of the child when the at least one task is completed and verified; verifying that the at least one task is completed by the designated timeframe; and crediting the portfolio of the child with the monetary reward when the completion of the task has been verified, the monetary reward being used for in-game purchases.

### TECHNICAL FIELD

The present application in general relates to video games, and more specifically, to a system and method that allows a parent or guardian to assign task to a child to perform in order to earn monetary rewards which may be used to make in-game purchases.

### BACKGROUND

It has always been a problem for parents to motivate children to perform daily household chores. Different devices have been used to try and encourage children to do their chores. For example, sticker charts have been used wherein parents reward the child with a sticker/star which may place next to the child's name once a chore is accomplished. As children get older, parents may encourage children to do their chores by giving them candy or other treats once a specific chore is done. Perhaps the most common way to encourage children to perform chores is through monetary means such as an allowance when the chores are completed.

Unfortunately, as mobile computing and gaming devices have become more popular, it has become more and more difficult to get children to do their chores. Even trying to restrict access to the mobile computing and gaming devices until chores have been completed has become difficult for parents as many children are able to figure out the parental controls on the mobile devices or are able to use public computing devices or friends' mobile computing and gaming devices for their gaming activities.

Many video games allow for in-game purchases. In-game purchases refer to items or points that a player can buy for use within a virtual world to improve a character or enhance the playing experience. The virtual goods that the player receives in exchange for real-world money are non-physical and are generally created by the game's producers. Examples of such in-game purchases may include, but is not limited to: (1) coins, points, diamonds, etc.: these are examples of in-game currency which can be redeemed for content, features, upgrades etc.; (2) levels/maps: certain extra levels or areas inside a game's universe may be unlocked via a digital purchase; (3) characters: new characters with varying skillsets can be acquired to play the game; (4) weapons/tools: upgraded weapons or tools to aid a player to progress in the game; and (5) appearance upgrades: these are items, not necessarily functional, may be worn by an avatar or be added to virtual belongings like cars, bikes or houses.

The global market for in-game purchases is estimated to hit about $30 billion (US). This is extraordinary considering that fewer than ten years ago it was zero. The problem with in-game purchasing is that most parents would prefer not to see their kids rack up spending on any kind of game. Further, the design of many of these games sends potentially confusing signals to children about fundamental economic ideas like value and pricing.

Therefore, it would be desirable to provide a system and method that overcomes the above. The system and method would encourage children to do their chores assigned by their parent(s) in order to earn monetary compensation. The system and method would verify the completion of the chore prior to awarding the monetary compensation. Upon earning the monetary compensation, the child may the use the monetary compensation to make in-game purchase. By having to perform certain chores/task to earn monetary compensation, the children may learn basic fundamental economic principals.

### SUMMARY

In accordance with one embodiment, a computer device is disclosed. The computer device has a processor, a display coupled to the processor, a user interface coupled to the processor for entering data into the computing device; and a memory coupled to the processor. The memory stores program instructions that when executed by the processor, causes the processor to: connect with a server hosting a task tracking and rewarding platform; enter at least one task to be performed by a child, the task having a monetary reward to be credited to a portfolio of the child; verify that the at least one task is completed by a designated timeframe; and credit the portfolio of the child with the monetary reward when the completion of the task has been verified, the monetary reward being used for in-game purchases.

In accordance with one embodiment, a method is disclosed. The method comprises: entering at least one task to be performed by a child, wherein the at least one task has a designated timeframe when the at least one task has to be completed and a monetary reward to be credited to a portfolio of the child when the at least one task is completed and verified; verifying that the at least one task is completed by the designated timeframe; and crediting the portfolio of the child with the monetary reward when the completion of the task has been verified, the monetary reward being used for in-game purchases.

In accordance with one embodiment, a method is disclosed. The method comprising: entering a plurality of tasks to be performed by a child, wherein each designated task has an associated designated timeframe for completion of each designated task, an associated monetary reward to be credited to a portfolio of the child when each designated task is completed and verified; verifying that each designated task is completed by the associated designated timeframe; and crediting the portfolio of the child with the associated monetary reward when each designated task has been completed and verified, the associated monetary reward being used for in-game purchases.

### BRIEF DESCRIPTION OF THE DRAWINGS

The present application is further detailed with respect to the following drawings. These figures are not intended to limit the scope of the present invention but rather illustrate certain attributes thereof.

FIG. 1 is a diagram of an exemplary monetary reward system according to one aspect of the present application;

FIG. 2 is a simplified block diagram showing an illustrative server device depicted in FIG. 1 in accordance with one aspect of the present application; and

FIG. 3 an exemplary embodiment of a flowchart depicting a method for awarding monetary compensation for completion of a chore/task according to one aspect of the present application.

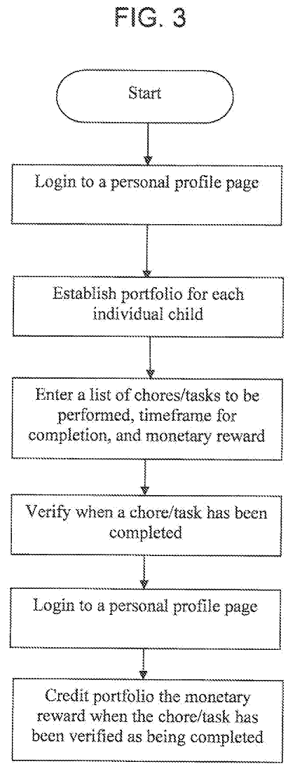

### DESCRIPTION OF THE APPLICATION

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

Embodiments of the exemplary system and method relates to a system and method that would encourage children to do their chores assigned by their parent(s) by providing monetary compensation. Upon completion of the chore, the child will send documented proof of completion. The system will verify the documentation and upon verification will credit the child's account with a predetermined monetary award. The child may then use the monetary award to make in-game purchases. By having to perform certain chores/task to earn monetary compensation, the children may learn basic fundamental economic principals.

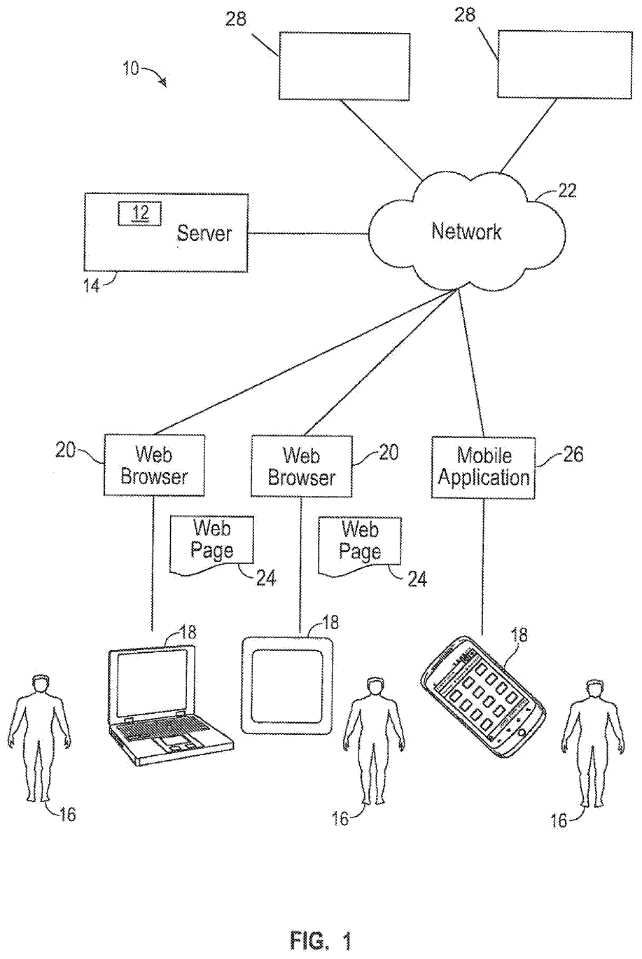

Referring now to FIG. 1, a monetary reward verification system 10 (hereinafter system 10) may be shown. The system 10 may provide a platform 12 that may allow for parent(s) (hereinafter parent) to establish an account wherein the parent may assign their child/children (hereinafter child) certain chores/task (hereinafter chores). The platform 12 may verify that the chores has been completed by the child assigned the chore. Once the chore has been completed and verified, the platform 12 may award the account a predetermined amount of in-game currency to the account. The child may then use the in-game currency to make in-game purchases. The platform 12 may allow the parent to establish individual portfolios for each child and to credit in-game currency to a specified portfolio. The platform 12 may notify the parent when a chore is or is not completed and may allow the parent to penalize the child if a chore is not done in a timely manner. That and other features of the platform 12 may be disclosed below.

The system 10 may have a server 14. The server 14 may be used to host the platform 12 of the present invention. A parent/individual 16 may use one or more computing devices 18 to access the platform 12 that may be hosted on the server 14. The computing devices 18 may be a personal computer system, tablet device, handheld or laptop device, mobile phone device, server computer system, multiprocessor system, microprocessor-based system, set top boxes, programmable consumer electronics, network PCs, and distributed cloud computing environments that include any of the above systems or devices, and the like. The computing device 18 may be described in the general context of computer system executable instructions, such as program modules, being executed by a computer system as may be described below.

The computing device 18 may be loaded with an operating system. The operating system of the computing device 18 may manage hardware and software resources of the computing device 18 and provide common services for computer programs running on the computing device 18. The computing device 18 may be loaded with a web browser 20. The web browser 20 may allow the computing device 18 to gain online access to a network 22 such as the World Wide Web. The web browser 20 may be Microsoft® Internet Explorer, Google® Chrome, Mozilla® Firefox, Apple® Safari or similar browsing applications. By connecting to the network 22, the computing device 18 may access a website 24 associated with the platform 12 hosted on the server 14.

Alternatively, or in addition to, the computing device 18 may download a mobile application 26. The mobile application 26 may access and communicate with the platform 12 hosted on the server 14. By connecting to the network 22, the computing device 18 may access and communicate with the platform 12 hosted on the server 14 via the mobile application 26.

The system 10 may have one or more gaming servers 28. The gaming servers 28 may be used to host one or more multiplayer video games. The gaming servers 28 may transmits enough data about its internal state to allow its connected clients to maintain their own accurate version of the game world for display to players. By connecting to the network 22, the computing device 18 may access a website associated with the multiplayer game hosted on the gaming server 28.

Alternatively, or in addition to, the computing device 18 may download a mobile application. The mobile application may access and communicate with the multi-player game hosted on the gaming server 28. By connecting to the network 22, the computing device 18 may access and communicate with the multi-player game hosted on the gaming server 28 via the mobile application.

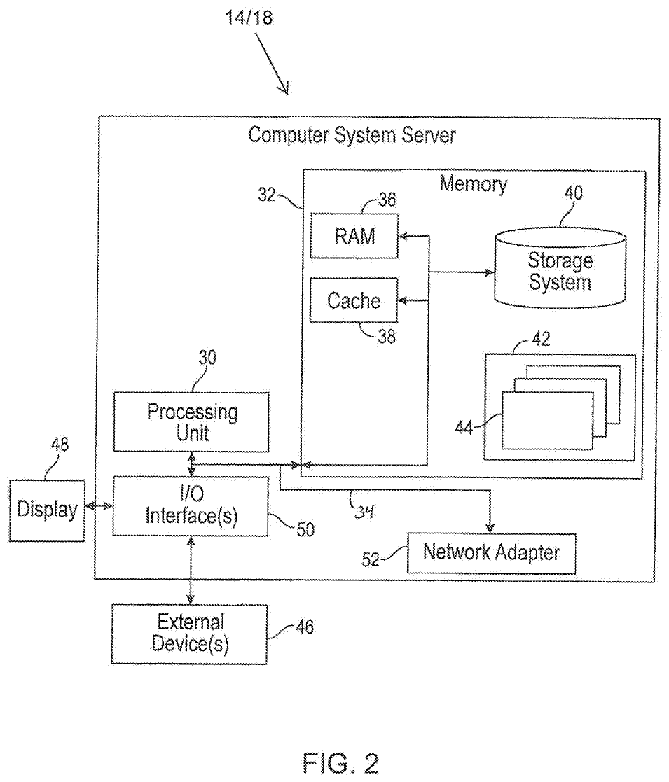

Referring now to FIG. 2, the server 14 and the computing devices 18 may be described in more detail in terms of the machine elements that provide functionality to the systems and methods disclosed herein. The components of the server 14 and computing devices 18 may include, but are not limited to, one or more processors or processing units 30, a system memory 32, and a system bus 34 that couples various system components including the system memory 32 to the processor 30. The server 14 and computing devices 18 may typically include a variety of computer system readable media. Such media could be chosen from any available media that is accessible by the server 14 and computing devices including non-transitory, volatile and non-volatile media, removable and non-removable media. The system memory 32 could include one or more computer system readable media in the form of volatile memory, such as a random-access memory (RAM) 36 and/or a cache memory 38. By way of example only, a storage system 40 may be provided for reading from and writing to a non-removable, non-volatile magnetic media device typically called a “hard drive”.

The system memory 32 may include at least one program product/utility 42 having a set (e.g., at least one) of program modules 44 that may be configured to carry out the functions of embodiments of the invention. The program modules 44 may include, but is not limited to, an operating system, one or more application programs, other program modules, and program data. Each of the operating systems, one or more application programs, other program modules, and program data or some combination thereof, may include an implementation of a networking environment. The program modules 44 generally carry out the functions and/or methodologies of embodiments of the invention as described herein. For example, the program modules 44 may carry out the steps that may allow for a parent to establish an account wherein the parent may assign their child certain chores, verify that the chores have been completed by the child assigned the chore, and award the account a predetermined amount of in-game currency once the completion of the chore is verified. The child may then use the in-game currency to make in-game purchases and other functionality as will be described below.

The server 14 and computing device 18 may communicate with one or more external devices 46 such as a keyboard, a pointing device, a display 48, and/or any similar devices (e.g., network card, modern, etc.) that enable the server 14 and computing device 18 to communicate with each other. Such communication may occur via Input/Output (I/O) interfaces 50. Alternatively, the computing devices 18 may communicate with one or more networks such as a local area network (LAN), a general wide area network (WAN), and/or a public network (e.g., the network 24 shown in FIG. 1) via a network adapter 52. As depicted, the network adapter 52 may communicate with the other components of the computing device 18 via the bus 36.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, microcode, etc.) or an embodiment combining software and hardware aspects that may all generally be referred to herein as a “circuit,” “module,” or “system.” Furthermore, aspects of the disclosed invention may take the form of a computer program product embodied in one or more computer readable media having computer readable program code embodied thereon.

Any combination of one or more computer readable media (for example, storage system 40) may be utilized. In the context of this disclosure, a computer readable storage medium may be any tangible or non-transitory medium that can contain, or store a program (for example, the program product 42) for use by or in connection with an instruction execution system, apparatus, or device. A computer readable storage medium may be, for example, but not limited to, an electronic, magnetic, optical, electromagnetic, infrared, or semiconductor system, apparatus, or device, or any suitable combination of the foregoing.

Referring to the FIGs, one embodiment of operation of the platform 12 may be described. To access the platform 12, a parent/individual 16 (hereinafter individual 16) may access the webpage 24 or download the mobile application 26 via a computing device 18 of the individual 16. The mobile application 26 may be downloaded from iTunes®, Google Play®, Apotide® or other similar mobile application download sites. Once the individual 16 accesses the webpage 24 or opens the mobile application 26, the individual 16 may see a login screen. The login screen may have a User ID area and a password area. Once the individual 16 enters the corresponding user information in the User ID area and the password area, the individual 16 may press a login button using an external device 46 (i.e. keyboard, mouse, etc.) of the computing device 18 of the individual 16. The user information may be sent to the server 14 hosting the platform 12 for verification. If the user information of the individual 16 is verified, the individual 16 may be sent to a personalized profile page of the individual 16 which may be described below. A link may be provided if the individual 16 cannot remember his/her User ID/password. By selecting the link using an external device 46 of the computing device 18 of the individual 16, the individual 16 may be sent to reset password page wherein the individual 16 may reset his/her password after a verification process.

The login screen may have a link to review the terms and conditions of signing up and accessing the platform 12. Selecting the link using an external device 46 of the computing device 18 of the individual 16 may send the individual 16 to a terms and condition page outlining the legal arrangement between the owners of the platform 12 and the individual 16 joining/accessing the platform 12.

If the individual 16 is new to the network platform 12, the login screen may have a new member link for the individual 16 to register and become a member of the platform 12. By selecting the new member link using an external device 46 of the computing device 18 of the individual 16, the individual 16 may be sent to a registration page. The registration page 70 may have a User ID area for entering a User name of the individual 16 and a password area for entering a user password. In accordance with one embodiment the User ID may be an email address of the individual 16. A confirmation area may be provided on the registration page for the individual to confirm that the User name. In accordance with one embodiment, additional information may need to be submitted on the registration page. For example, an age verification area may be provided to allow one to confirm that the individual 16 is above a certain age. A cellular phone area may be provided to provide an additional level of security. A verification code area may be provided to help prevent disruptive use of automotive programs. Additional user information areas may be provided to allow the individual 16 to provide additional user information such as a user's actual name, date of birth, sex, and similar information.

Once the individual 16 has entered the information in the User ID area and the confirmation area, the individual 16 may press a submit button via an external device 46 of the computing device 18 of the individual 16. The User ID information may be sent to the server 14 to verify if the user ID is available. If the User ID is available, the server 14 may send a notification asking if the individual 16 would like to receive alerts sent by the server 14 regarding the account of the individual 16. The alerts received on the computing device 18 of the individual 16 may be set in the “Settings” page of the computing device 18 of the individual 16.

If the User ID is available, the server 14 may send a temporary password to the individual 16. The temporary password may be sent via email, text, or other suitable communication means.

When the individual 16 enters the temporary password and presses a submit button 76 via an external device 46 of the computing device 18 of the individual 16, the user information may be sent to the server 14 hosting the platform 12 for verification. If the user information of the individual 16 is verified, the individual 16 may be sent to a personalized profile page of the individual 16. Here, the individual 16 may reset the password. Alternatively, the individual may be sent to a reset password page. The reset password page may allow the individual to set-up a desired password. Once the desired password is established and entered, the individual 16 may be sent to a personalized profile page of the individual 16.

Once the individual 16 has been sent to the personalized profile page of the individual 16, the individual 16 may set-up the personalized profile page. On the personalized profile page, the individual 16 may establish individual portfolios for each child. Each portfolio may have basic information about the child such as the child's name and contact information such as an email address, SMS number or the like for the child. The individual 16 may set-up a child login in order for the child to access the portfolio using the external device 46 of the computing device 18 of the individual 16. The child login may include a child User ID and child password. Alternatively, or in addition to, the individual 16 may set-up the child login to accept bio-metric information. For example, the individual 16 may set-up the child's portfolio so that the child may access the portfolio by entering certain bio-metric information such as a fingerprint data, facial data, retinal data, voice data or the like. Thus, in the above examples, the child may access his/her portfolio by placing his/her finger on a fingerprint scanner on a designated computing device 18, or by scanning his/her face with a camera on the designated computing device 18, or by using a retinal scanner on the designed computing device 18, or by speaking into a microphone in the designated computing device 18. The above is given as an example and should not be seen in a limiting manner. Other login methods may be used without departing from the spirit and scope of the present invention. While the child may access his/her respective portfolio, the child cannot make any changes to the portfolio. Thus, a child cannot change his/her password or User ID. Only the individual 16 setting up the portfolio may make changes to the respective portfolio. Each portfolio may allow the individual 16 to download games to the portfolio, set guidelines as to the amount of time a child may be online, the types of online games to be played, types of in-game purchase and the like. Thus, the individual 16 may set parental guidelines to set age appropriate content/purchases on each portfolio. For example, the individual 16 may set-up guidelines that the child may only play online games having an Entertainment Software Rating Board (ESRB) rating of E. The individual 16 may set the amount of time the child may be online (i.e., 10 hours/week) and a specific time when the child may be online (i.e. Monday-Thursday 7:00 pm-8:00 pm). If the child tries to login to the portfolio during a time the child is not allowed to play or after the child has used his/her amount of time, the child will not be able to engage the online games. The above is given as an example and should not be seen in a limiting manner. Other parental guidelines may be established without departing from the spirit and scope of the present invention.

Each portfolio may have a spreadsheet. The spreadsheet may allow the individual 16 to enter a chore/task to be done by a specific child. The individual 16 may enter the chore that needs to be completed, the timeframe for completing the chore, and the amount of monetary reward the child gets for performing the chore. For example, the individual 16 may add: Chore: Make the Bed; Timeframe: Everyday by 8:00 am; Monetary Reward: $0.25/day; Chore: Take Out Trash; Timeframe: Every Wednesday by 7:00 pm; Monetary Reward: $1.00; Chore: Mow the Lawn; Timeframe: Every Saturday by noon; Monetary Reward: $2.00. The above is given as examples and should not be seen in a limiting manner. Other chores/task may be used without departing from the spirit and scope of the present invention.

The spreadsheet may have a violation management section. The violation management section may allow the individual 16 to customize how the child is penalized depending on their parenting style. These options include no penalties “Warn”, penalize immediately which will reduce tokens, reduce a % of the total weekly allowance. A parent may also define the percent of tokens to reduce with each incident uncompleted. Whatever configuration defined, the system will apply according.

For example, in the violation management section, the individual 16 may set penalties for each chore that is not done in a timely manner. The individual 16 may set-up the violation management section so that a warning may be given to the child for a first violation. After that, the violation management section may automatically reduce the monetary reward based on the setting established by the individual 16. The violation management section may alert the individual 16 by email, SMS message and/or other communication mechanisms about the violation and reduction of monetary reward. For example, in the above example of Chore: Take Out Trash; Timeframe: Every Wednesday by 7:00 pm; Monetary Reward: $1.00; the individual 16 may set the violation management section to reduce the monetary reward $0.25 every 15 minutes. Thus, at 7:16 pm, the monetary reward would be reduced to $0.75; at 7:31 pm, the monetary reward would be reduced to $0.50. This will continue until the monetary reward is reduced to $0.00. The violation management section may notify the individual 16 when the chores is not done by a predefined timeframe. For example, in the above case, the individual 16 may set an alert once it is 8:01 pm and the chores has not been completed and the monetary reward has been reduced to $0.00. If the child is getting a set allowance for all completed and verified task/chores, the platform may monitor and automatically reduce the total allowance awarded based on reductions calculated by the violation management section.

Once the spreadsheet has been established by the individual 16, a notification may be sent to the child. The notification may be used to let the child know of the chores he/she has to perform in order to receive a monetary reward. The notification may be an email, SMS, or other communication mechanisms. The notification may be a hyperlink which the child may “click” to see the spreadsheet or the child may login to his/her portfolio to see the spreadsheet. The above are given as examples and should not be seen in a limiting manner. Other notification may be used without departing from the spirit and scope of the present invention.

The platform 12 may be used to verify that the chore has been completed by the designated timeframe and then automatically credit the portfolio of the child. Verification may be done in different manners. For example, one verification process may be a manual verification process. Once a chore has been completed and/or the timeframe for completing the chore has elapsed, the individual 16 may see if the chore has been completed in a proper manner. Once the individual 16 verifies that a chore is done, the individual 16 may access the portfolio of the child to verify that the chores has been done in a satisfactory manner and the platform 12 may then automatically credit the portfolio. If the individual 16 determines that the chores have not been done, then the individual 16 does not have to do anything and the portfolio will not be credited.

However, there may be times when the individual 16 is not around to verify. Thus, the platform 12 may have an auto-verification module. The auto-verification module may use photo recognition to verify that a chore has been completed. In accordance with one embodiment, the child may be asked to take a photograph of the finished chore. For example, for the chore of, Chore: Make the Bed; Timeframe: Everyday by 8:00 am; Monetary Reward: $0.25/day, the child may be required to take a photograph of the bed after the bed has been made with the bedcover. The photograph may need to be sent prior to the 8:00 am deadline if the child wishes to receive the full monetary reward. When the photograph is received by the platform 12, the platform 12 may use metadata from the photograph to auto-approve that the chore has been completed and auto-credit the portfolio the monetary reward. In accordance with one embodiment, the platform 12 may use time and geodata of the photograph to verify if the chore was done in a timely manner. For example, the platform 12 may look at a time stamp and location of where the photograph was taken. If the location is not within 100 yards of the address where the chore is to be completed, the platform may not approve that the chore is completed. Similarly, if the time stamp on the photograph is sent after 8:00 am, the child may not receive the full monetary reward. If the portfolio is set-up with a violation management system as disclosed above, if the photograph is sent after 9:00 am, the child may receive no monetary reward.

The platform 12 may save the photograph for review by the individual 16. In this embodiment, the individual may review the photograph and void the monetary reward should the individual 16 determine that the chore was not done in a satisfactory manner. For example, in the above chore of making the bed, if the photograph shows that the bedspread is not properly spread-out and covering the bed and/or has too many wrinkles, the individual 16 may void the monetary reward. The platform 12 may then automatically remove the awarded amount.

In accordance with another embodiment, the platform may have a photo recognition module. The photo recognition module may work in conjunction with the time and geodata of the photograph as disclosed above, or as a stand-alone verification mechanism. The photo recognition module may recognize predetermined images/objects to determine if the chore was completed. For example, the photo recognition module may use an algorithm to compare a current photograph of the bed that the child made to a base photograph of a bed that is made to determine if the chore of making the bed was accomplished. The photograph may need to be sent prior to the designated time deadline if the child wishes to receive the full monetary reward.

In accordance with one embodiment, the child may be required to send a before and after picture. In this way, the photo recognition module may compare the before and after photographs to determine if the chore is properly completed. If the photo recognition module determines that the chore was done properly and timely, the platform 12 may auto-credit the portfolio the monetary reward. In this embodiment, the platform 12 may save the photographs for review by the individual 16. The individual may review the photographs and void the monetary reward should the individual 16 determine that the chore was not done in a satisfactory manner. The platform 12 may then automatically remove the awarded amount if the individual 16 determines that the chore was not properly done.

Once the platform 12 has determined that a chore has been completed properly and in a timely manner, the platform may automatically credit the portfolio of the child with the predetermined monetary reward. In accordance with one embodiment, when the individual 16 registers, the individual 16 may enter a bank account number, a credit card number or some other financial account number. In accordance with one embodiment, the platform may be configured to accept certified digital currency, i.e., crypto currency. Thus, crypto currency such as Litecoin (LTC) Litecoin, Ethereum (ETH), Zcash (ZEC), Dash (DASH), Ripple (XRP), Monero (XMR) and other certified digital currency may be used.

The account number may then be charged after the chore has been completed and verified and the portfolio may then be credited with the proper monetary reward. In accordance with one embodiment, the monetary reward is converted to digital in-game currency. Thus, in this embodiment, the child does not actually receive the monetary reward. Instead, the child receives an equivalent amount of digital in-game currency which is equal to the monetary reward. For example, if $1.00 USD is equal to 10 digital in-game currency tokens, and the child completes a chore that is worth $1.00 USD, the child's portfolio would be credited with 10 digital in-game currency tokens. The child may then use the digital in-game currency in his/her portfolio to make in-games purchase. The digital in-game currency does have a monetary value which will be used as a basis to prevent cannibalization of in-app purchase. In the above example, 1 digital in-game currency token is valued at $0.10 USD. Therefore, if an item in the game is worth $0.50 USD the child will spend 5 digital in-game currency tokens.

In accordance with one embodiment, the online game which the child wishes to make in-games purchase has to be linked to the child's portfolio or be configured to accept the digital in-game currency of the portfolio. This could be an additional mechanism which may allow the individual 16 to control which games the child is playing. Thus, the only way a child may use the digital in-game currency in his/her portfolio is to log into his/her portfolio and play an online game in his/her respective portfolio.

An individual 16 may set-up the portfolio to disable in-app purchase from a mobile app that uses a monetary currency when a child is logged into his/her portfolio. For example, to buy 10 lives, it may cost $1.00 USD from the games' in-app store. The individual may have the ability to disable this use case. Instead, the child can use 10 digital in-game currency tokens to obtain 10 lives in a similar store on the platform 12. A developer may also decide to have different items in the store depending on the type of currency (USD or digital in-game currency tokens).

The platform 12 may have a social funding mechanism. The social funding mechanism may allow for the individual 16 to set-up an account in a portfolio to allow others to donate a monetary amount to a child for a special event/cause. For example, for the child's birthday, the individual 16 may use the social funding mechanism to allow others to contribute a monetary reward to the child's portfolio for the child's birthday. This will allow the child to more easily make in-game purchases. If someone to give cash to the child, the child would then have to give the cash to the individual 16 and have the individual 16 log into the game which the child wishes to make an in-game purchases and make the purchase using a credit card or other financial mechanism to the make the in-game purchase.

It should be noted that the individual 16 may set-up how the child will receive the monetary reward for doing his/her chores/task in the portfolio. For example, the individual 16 may set-up the portfolio so that the child gets rewarded for each task/chore completed. Alternatively, the individual 16 may set-up the portfolio so that the child only gets rewarded if all the chores/task assigned for the week are completed in a timely manner. Thus, the individual 16 can apply an “All or Nothing” setting which requires the child to complete all the items on the spreadsheet before any rewards are dispersed, or the individual 16 may approve to release a reward within the spreadsheet as it gets done.

The foregoing description is illustrative of particular embodiments of the invention, but is not meant to be a limitation upon the practice thereof. The following claims, including all equivalents thereof, are intended to define the scope of the invention.

What is claimed is:

1. A computing device comprising:
a processor;
a display coupled to the processor;
a user interface coupled to the processor for entering data into the computing device; and
a memory coupled to the processor, the memory storing program instructions that when executed by the processor, causes the processor to:
connect with a server hosting a task tracking and rewarding platform;
enter at least one task to be performed by a child, the task having a monetary reward to be credited to a portfolio of the child;
verify that the at least one task is completed by a designated timeframe; and
credit the portfolio of the child with the monetary reward when the completion of the task has been verified, the monetary reward being used for in-game purchases.

2. The computing device of claim 1, wherein verifying that the at least one task is completed by a designated timeframe comprises entering a photograph of the at least one task completed, wherein the memory storing program instructions that when executed by the processor, causes the processor to:
read metadata of the photograph;
compare a time and location on the metadata to a time when the at least one task had to be completed and to a location where the at least one task had to be completed; and
verify that the at least one task is completed when the time on the metadata is on or before the time when the at least one task had to be completed and the location on the metadata is within a predetermined distance of the location where the at least one task had to be completed.

3. The computing device of claim 1, wherein verifying that the at least one task is completed by a designated timeframe comprises entering a photograph of the at least one task completed, wherein the memory storing program instructions that when executed by the processor, causes the processor to:
perform photo recognition to determine if the at least one task has been completed; and
compare a time between when the photograph was sent and the designated timeframe to determine if the at least one task has been completed by the designated timeframe.

4. The computing device of claim 1, wherein verifying that the at least one task is completed by a designated timeframe comprises:
entering a first photograph of the at least one task to be performed prior to performing the at least one task;
entering a second photograph of the at least one task to be performed after the at least one task has been completed, wherein the memory storing program instructions that when executed by the processor, causes the processor to:
perform photo recognition to compare the first photograph to the second photograph to determine if the at least one chore has been completed; and
compare a time between when the second photograph was sent and the designated timeframe to determine if the at least one task has been completed by the designated timeframe.

5. The computing device of claim 1, wherein crediting the portfolio of the child with the monetary reward when the completion of the task has been verified, the monetary reward being used for in-game purchases comprises:
entering a monetary account number; and
charging the monetary account number after verifying that the at least one task is completed; and
crediting the portfolio with the monetary reward.

6. The computing device of claim 5, wherein the monetary account number is one of a bank account number, a credit card number, a crypto-currency account number or other financial account number.

7. The computing device of claim 5, wherein entering at least one task to be performed comprises entering a penalty for the at least one task when the at least one task is not performed by the designated timeframe, wherein the memory storing program instructions that when executed by the processor, causes the processor to:
reduce the monetary award a predetermined amount at predetermined time intervals; and
eliminate the monetary reward if the at least one task is not completed by a maximum timeframe.

8. A method comprising:
entering at least one task to be performed by a child, wherein the at least one task has a designated timeframe when the at least one task has to be completed and a monetary reward to be credited to a portfolio of the child when the at least one task is completed and verified;
verifying that the at least one task is completed by the designated timeframe; and
crediting the portfolio of the child with the monetary reward when the completion of the task has been verified, the monetary reward being used for in-game purchases.

9. The method of claim 8, wherein verifying that the at least one task is completed by a designated timeframe comprises:
entering a photograph of the at least one task completed
reading metadata of the photograph;
comparing a time and location on the metadata to a time when the at least one task had to be completed and to a location where the at least one task had to be completed; and
verifying that the at least one task is completed when the time on the metadata is on or before the time when the at least one task had to be completed and the location on the metadata is within a predetermined distance of the location where the at least one task had to be completed.

10. The method of claim 8, wherein verifying that the at least one task is completed by a designated timeframe comprises:
entering a photograph of the at least one task completed;
performing photo recognition to determine if the at least one task has been completed; and
comparing a time between when the photograph was sent and the designated timeframe to determine if the at least one task has been completed by the designated timeframe.

11. The method of claim 8, wherein verifying that the at least one task is completed by a designated timeframe comprises:
entering a first photograph of the at least one task to be performed prior to performing the at least one task;
entering a second photograph of the at least one task to be performed after the at least one task has been completed;
perform photo recognition to compare the first photograph to the second photograph to determine if the at least one task has been completed; and
compare when the second photograph was sent to the designated timeframe to determine if the at least one task has been completed by the designated timeframe.

12. The method of claim 8, wherein crediting the portfolio of the child with the monetary reward when the completion of the task has been verified, the monetary reward being used for in-game purchases comprises:
entering a monetary account number; and
charging the monetary account number after verifying that the at least one task is completed.

13. The method of claim 12, comprising crediting the portfolio of the child with the monetary reward when the completion of the task has been verified, the monetary reward being used for in-game purchases.

14. The method of claim 12, wherein the monetary account number is one of a bank account number, a credit card number, a crypto-currency account number or other financial account number.

15. The method of claim 8, wherein entering at least one task to be performed comprises entering a penalty for the at least one task when the at least one task is not being performed by the designated timeframe.

16. The method of claim 16, comprising:
reducing the monetary award, a predetermined amount at predetermined time intervals; and
eliminating the monetary reward if the at least one task is not completed by a maximum timeframe.

17. A method comprising:
entering a plurality of tasks to be performed by a child, wherein each designated task has an associated designated timeframe for completion of each designated task, an associated monetary reward to be credited to a portfolio of the child when each designated task is completed and verified;
verifying that each designated task is completed by the associated designated timeframe; and
crediting the portfolio of the child with the associated monetary reward when each designated task has been completed and verified, the associated monetary reward being used for in-game purchases.

18. The method of claim 17, wherein verifying each designated task is completed by the associated designated timeframe comprises:
entering a photograph of each designated task completed;
reading metadata of the photograph of each designated task completed;
comparing a time and location on the metadata to a corresponding associated designated timeframe of an associated designated task completed and to a location where the associated designated task had to be completed; and
verifying that the associated designated task is completed when the time on the metadata is on or before the corresponding associated designated timeframe and the location on the metadata is within a predetermined distance of the location where the associated designated task had to be completed.

19. The method of claim 17, wherein verifying that each task is completed by a designated timeframe comprises:
entering a photograph of each task completed;
performing photo recognition to determine if a corresponding task associated with a corresponding photograph entered has been completed; and
comparing a time between when the corresponding photograph was sent and a designated timeframe associated with the corresponding task completed to determine if the corresponding task has been completed by the designated timeframe associated with the corresponding task.

20. The method of claim 17, wherein verifying that each task is completed by a designated timeframe comprises:
entering a first photograph of each task to be performed prior to performing a task associated with the first photograph;
entering a second photograph of each task to be performed after the task associated with the first photograph has been completed;
perform photo recognition to compare the first photograph to the second photograph to determine the task associated with the first photograph has been completed; and
compare when the second photograph was sent to the designated timeframe to determine if the at least one task has been completed by the designated timeframe.
